(19) United States
(12) Patent Application Publication
(10) Pub. No.: US 2026/0250986 A1
(43) Pub. Date: Aug. 27, 2026

(54) INTERCHANGEABLE CORE WITH OFFSET CONTROL TUMBLER

(71) Applicant: Schlage Lock Company LLC, Carmel, IN (US)

(72) Inventor: Zachary Wiggins, Colorado Springs, CO (US)

(21) Appl. No.: 19/061,077

(22) Filed: Feb. 24, 2025

(51) Int. Cl. E05B 63/00; E05B 27/00

(52) U.S. Cl. CPC E05B 63/0056; E05B 27/0053; E05B 27/0078

(57) ABSTRACT

An exemplary lock cylinder generally includes a shell, a control member, a plug, a lock tumbler mechanism, and a control tumbler mechanism. The shell at least partially defines each of a chamber and a control tumbler shaft. The control member is mounted for rotation relative to the shell between a hold position and a release position, and further defines the control tumbler shaft. The plug is rotatably seated in the chamber and at least partially defines a lock tumbler shaft and the control tumbler shaft. The lock tumbler mechanism is seated in the lock tumbler shaft and operable to selectively prevent rotation of the plug relative to the shell. The control tumbler mechanism is seated in the control tumbler shaft and operable to alternately couple the control member with each of the shell and plug. The lock tumbler shaft and the control tumbler shaft are oblique to one another.

### TECHNICAL FIELD

The present disclosure generally relates to interchangeable core lock cylinders, and more particularly but not exclusively relates to retention mechanisms for interchangeable core lock cylinders.

### BACKGROUND

Interchangeable core lock cylinders can be installed to an outer housing and selectively retained in the outer housing by operation of a retention mechanism. While there are a variety of retention mechanisms, they typically fall into one of two categories. One category of retention mechanisms uses an otherwise standard key with a special combination to actuate the retention mechanism with an alternate shear line. The second category requires a special key that includes an additional feature to actuate the retention mechanism in a manner that the typical operating key cannot. Retention mechanisms of the latter type tend to use many small components and/or additional assembly processes, and sometimes do not positively lock the control lug, which can result in slop in the retention mechanism and/or leaving the retention mechanism in an unknown state. For these reasons among others, there remains a need for further improvements in this technological field.

### SUMMARY

An exemplary lock cylinder generally includes a shell, a control member, a plug, a lock tumbler mechanism, and a control tumbler mechanism. The shell at least partially defines each of a chamber and a control tumbler shaft. The control member is mounted for rotation relative to the shell between a hold position and a release position, and further defines the control tumbler shaft. The plug is rotatably seated in the chamber and at least partially defines a lock tumbler shaft and the control tumbler shaft. The lock tumbler mechanism is seated in the lock tumbler shaft and operable to selectively prevent rotation of the plug relative to the shell. The control tumbler mechanism is seated in the control tumbler shaft and operable to alternately couple the control member with each of the shell and plug. The lock tumbler shaft and the control tumbler shaft are oblique to one another. Further embodiments, forms, features, and aspects of the present application shall become apparent from the description and figures provided herewith.

### BRIEF DESCRIPTION OF THE FIGURES

FIG. 1 is a plan view of a lock cylinder according to certain embodiments installed to a housing.

FIG. 2 is a perspective illustration of a system including the lock cylinder.

FIG. 3 is an exploded assembly view of the lock cylinder.

FIG. 4 is a transverse cross-sectional view of the lock cylinder and illustrates a control tumbler mechanism.

FIG. 5 is a long cross-sectional view of the lock cylinder and illustrates a tumbler assembly in a locking state.

FIG. 6 is a transverse cross-sectional view of the lock cylinder and illustrates a control member in a holding position.

FIG. 7 is a transverse cross-sectional view of the lock cylinder and illustrates the control member in a release position.

FIG. 8 is a long cross-sectional view of the lock cylinder upon insertion of an operating key.

FIG. 9 is a long cross-sectional view of the lock cylinder upon insertion of a control key.

FIG. 10 is a transverse cross-section view of the lock cylinder and illustrates the control tumbler mechanism in a first state.

FIG. 11 is a transverse cross-section view of the lock cylinder and illustrates the control tumbler mechanism in a second state.

FIG. 12 is a transverse cross-section view of the lock cylinder with the control member rotated to its release position.

### DETAILED DESCRIPTION OF ILLUSTRATIVE EMBODIMENTS

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should further be appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Items listed in the form of “A, B, and/or C” can also mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

In the drawings, some structural or method features may be shown in certain specific arrangements and/or orderings. However, it should be appreciated that such specific arrangements and/or orderings may not necessarily be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may be omitted or may be combined with other features.

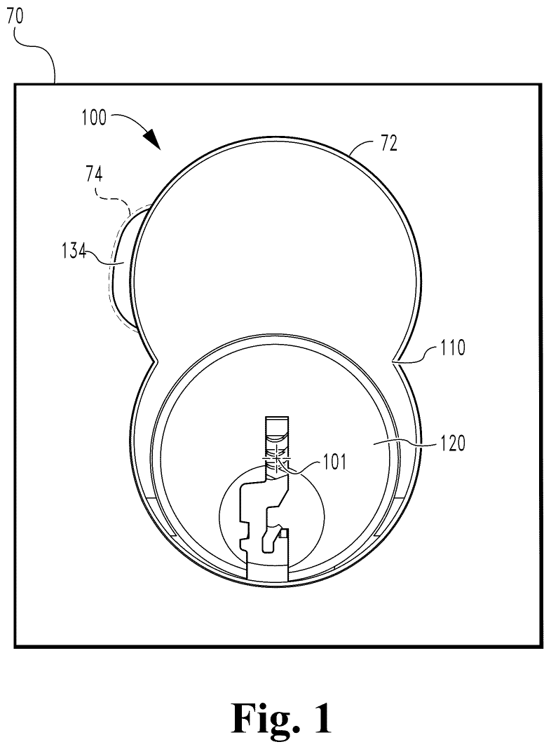

With reference to FIG. 1, illustrated therein is an interchangeable core lock cylinder 100 according to certain embodiments installed to a housing 70. The housing 70 includes a chamber 72 and a recess 74 defined adjacent the chamber 72. The lock cylinder 100 is seated in the chamber 72, and a control member 130 of the lock cylinder 100 is operable to engage the recess 74 to selectively prevent removal of the lock cylinder 100 from the housing 70.

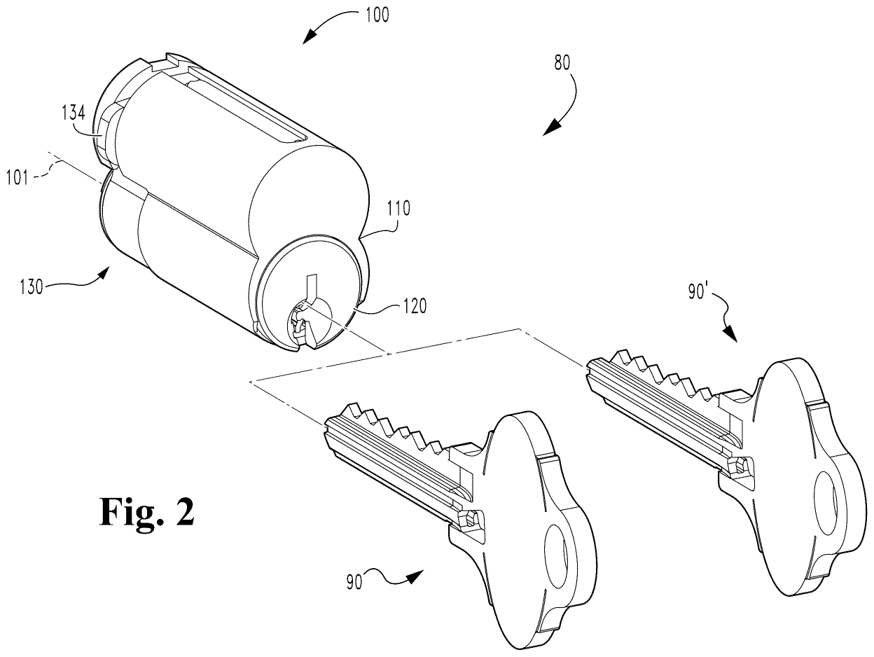

With additional reference to FIG. 2, a system 80 according to certain embodiments includes the lock cylinder 100, and further includes a pair of keys 90, 90′ operable to actuate the lock cylinder 100. More particularly, the illustrated system 80 includes an operating key 90 and a control key 90′, each of which is operable to cause the lock cylinder 100 to unlock. As described herein, the control key 90′ is also operable to cause the control member 130 to disengage from the recess 74 to thereby permit removal of the cylinder 100 from the housing 70. The operating key 90, by contrast, is inoperable to cause the control member 130 to disengage from the recess 74.

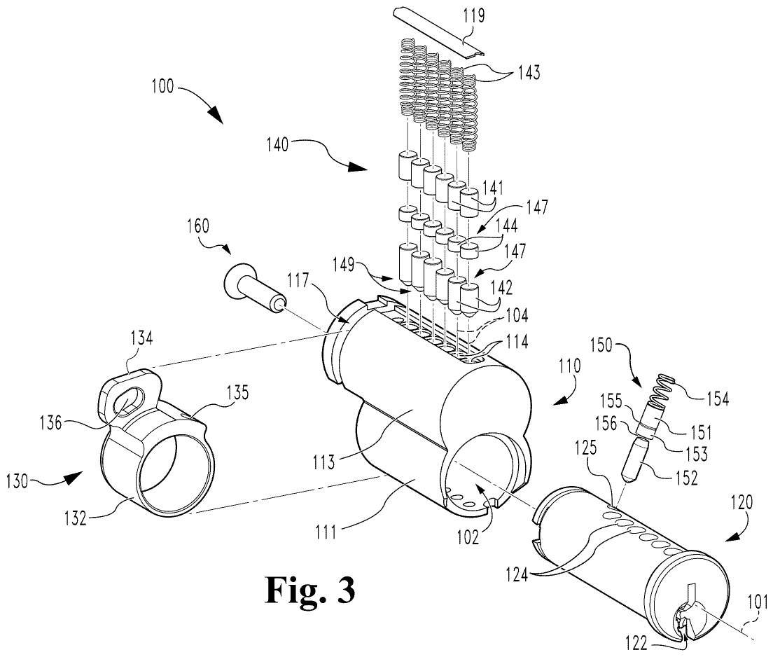

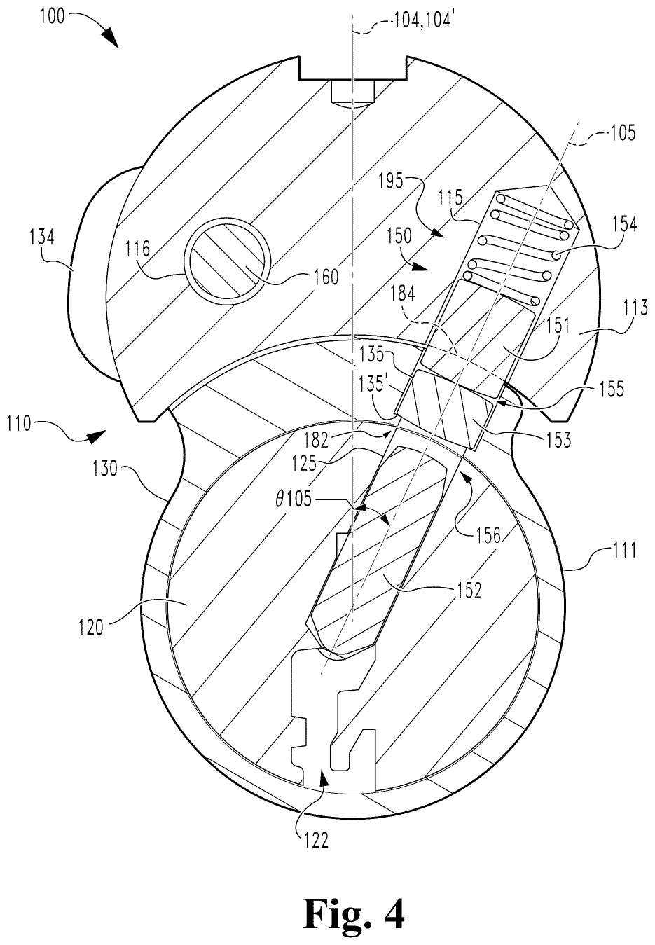

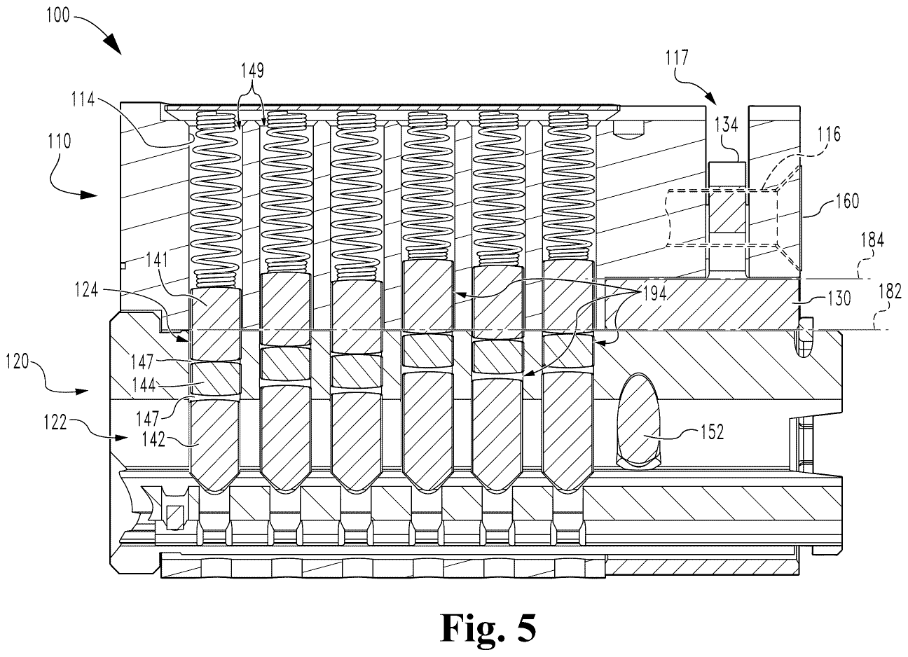

With additional reference to FIG. 3, the lock cylinder 100 generally includes a shell 110, a plug 120 mounted in the shell 110 for rotation about a longitudinal rotational axis 101 of the lock cylinder 100, and the control member 130, which is mounted to the plug 120 for rotation relative to the shell 110 and plug 120. The lock cylinder 100 further includes a lock tumbler assembly 140 operable to selectively prevent rotation of the plug 120 relative to the shell 110, and a control tumbler mechanism 150 operable to alternately lock the control member 130 to each of the shell 110 and the plug 120. In the illustrated form, the lock cylinder 100 further includes a stop member 160 operable to limit rotation of the control member 130 relative to the shell 110. As described herein, the lock tumbler assembly 140 includes a plurality of lock tumbler mechanisms 149, each of which is received in a corresponding lock tumbler shaft 194 (FIG. 5). Moreover, the lock cylinder 100 also defines a control tumbler shaft 195 (FIG. 4) that extends transverse to the lock tumbler shafts 194 and receives the control tumbler mechanism 150.

With additional reference to FIGS. 4 and 5, the shell 110 generally includes a body portion 111 operable to receive a portion of the plug 120, and a tower 113 extending radially from the body portion 111. The body portion 111 partially defines a chamber 102 that extends along the longitudinal axis 101 and rotatably receives the plug 120. The body portion 111 is shorter along the longitudinal axis 101 than the tower 113 such that the tower 113 extends axially beyond the distal end of the body portion 111. The illustrated tower 113 includes a plurality of shell lock tumbler cavities 114 and a shell control tumbler cavity 115. In the illustrated form, the shell control tumbler cavity 115 is provided in the form of a blind bore 115. It is also contemplated that the shell control tumbler cavity 115 may be provided in another form. For example, the blind bore 115 may be replaced by a through bore and a cover that encloses the shell control tumbler cavity 115. The illustrated tower 113 further defines a longitudinal bore 116 that receives the stop member 160, and a transverse slot 117 that intersects the longitudinal bore 116.

Each shell lock tumbler cavity 114 partially defines a corresponding lock tumbler shaft 194 for receiving a respective tumbler mechanism 149 of the tumbler assembly 140. Similarly, the shell control tumbler cavity 115 partially defines the control tumbler shaft 195, which receives the control tumbler mechanism 150. Each of the lock tumbler shafts 194 extends along a corresponding and respective lock tumbler axis 104, and the control tumbler shaft extends along a control tumbler axis 105. Moreover, the lock tumbler axes 104 extend along and define a reference plane 104′, and the control tumbler axis 105 extends at an oblique angle θ105 relative to the reference plane 104′.

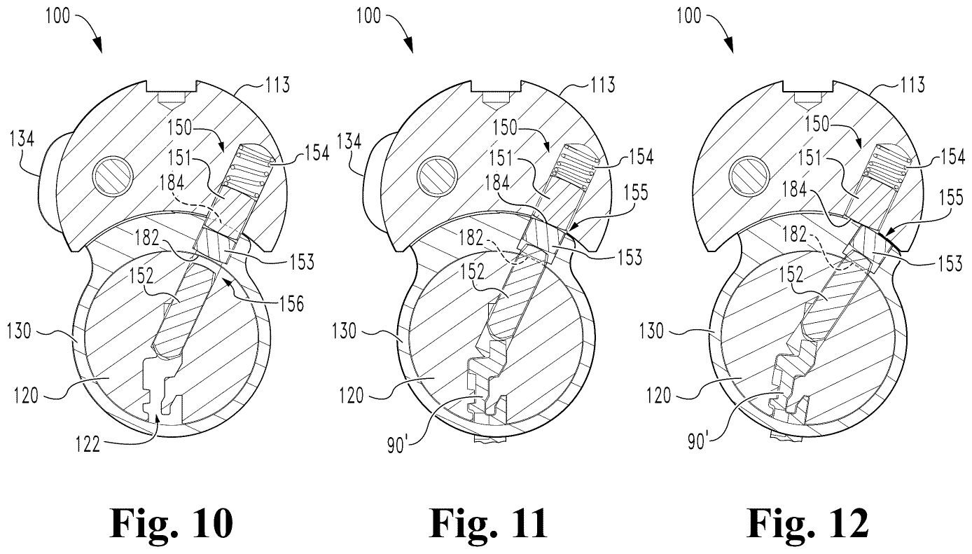

The plug 120 is seated in the chamber 102 for rotation about the longitudinal rotational axis 101 between a home position (FIG. 10), a rotated position (FIG. 12), and an unlocking position. The plug 120 includes a keyway 122 operable to receive a shank 92 of the key 90, a plurality of plug tumbler cavities 124 extending from the keyway 122, and a control tumbler cavity 125 that is positioned distal to the plug tumbler cavities 124 and receives a portion of the control tumbler mechanism 150. The plug tumbler cavities 124 partially define the lock tumbler shafts 194, and the control tumbler cavity 125 partially defines the control tumbler shaft 195. When the plug 120 is in its home position (FIG. 4), the keyway 122 and the plug tumbler cavities 124 align with the shell tumbler cavities 114 and occupy the reference plane 104′, while the plug control tumbler cavity 125 aligns with the shell control tumbler cavity 115 to thereby define a continuous control tumbler shaft 195.

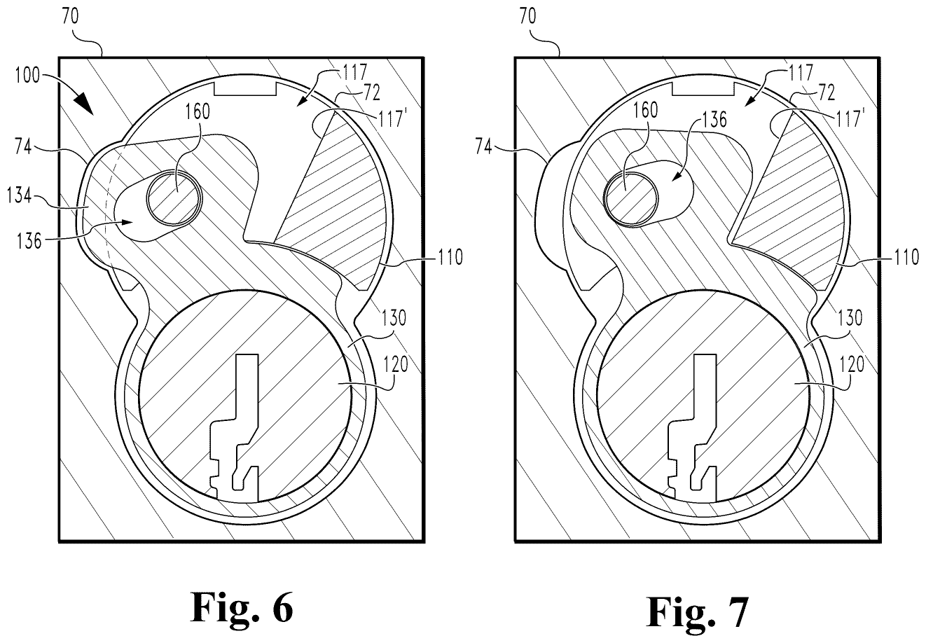

With additional reference to FIGS. 6 and 7, the control member 130 includes a sleeve 132 that partially defines the chamber 102 and rotatably receives a distal portion of the plug 120. The control lug 134 extends radially from the sleeve 132 and is operable to enter the recess 74 to selectively prevent removal of the lock cylinder 100 from the housing 70. The control member 130 also includes an aperture 135, which partially defines the control tumbler shaft 195 and is operable to receive a portion of the control tumbler mechanism 150. As described herein, the control member 130 is rotatable about the longitudinal rotational axis 101 between a holding position (FIG. 6) in which the control lug 134 projects beyond the axial footprint of the tower 113 and is operable to removal of the lock cylinder 100 from the housing 70, and a release position (FIG. 7) in which the control lug 134 is received in the transverse slot 117 and is inoperable to prevent removal of the lock cylinder 100 from the housing 70. In the illustrated form, the control member 130 further includes a limiting slot 136 that receives the stop member 160 to thereby limit the control member 130 to rotation between the holding position and the release position.

As noted above, the plug 120 is rotatably seated in the chamber 102. A proximal portion of the chamber 102 is defined by the body portion 111 of the shell 110, and a distal portion of the chamber 102 is defined by the sleeve 132 of the control member 130. An inner shear line 182 is defined between the outer surface of the plug 120 and the inner surfaces defining the chamber 102. Moreover, an outer shear line 184 is defined between an outer surface of the control member 130 and an inner surface of the tower 113. As will be appreciated by those skilled in the art, a tumbler crossing a shear line can prevent relative rotation of the components defining the shear line. Further details regarding components that cross the shear lines 182, 184 are provided herein.

The lock tumbler assembly 140 is operable to selectively prevent rotation of the plug 120 relative to the shell 110. The lock tumbler assembly 140 includes a plurality of lock tumbler mechanisms 149, each of which is seated in a corresponding one of the lock tumbler shafts 194. While other forms are contemplated, in the illustrated form, the lock tumbler assembly 140 is provided in the form of a pin tumbler assembly 140, and each lock tumbler mechanism 149 is provided as a pin tumbler mechanism 149. Each of the illustrated pin tumbler mechanisms 149 includes a corresponding driver pin 141 slidably disposed in a respective shell lock tumbler cavity 114, a corresponding key pin 142 slidably disposed in a respective plug lock tumbler cavity 124, and a corresponding bias member 143 disposed in the shell tumbler cavity 114 and biasing the driver pin 141 toward the plug 120. The lock tumbler mechanisms 149 may be retained within the lock cylinder 100 by a plate 119 that covers the shell lock tumbler cavities 114 to thereby enclose the lock tumbler shafts 194. In the illustrated form, one or more of the lock tumbler mechanisms 149 further includes one or more master key pins 144 disposed between the driver pin 141 and the key pin 142 to thereby increase the number of key codes operable to actuate the lock cylinder 100.

In the illustrated form, each tumbler mechanism 149 includes one or more interfaces or breaks 147, each of which is defined between two of the tumblers. For example, one break 147 may be formed between the driver pin 141 and the master pin 144, and another break 147 may be formed between the key pin 142 and the master pin 144. It is also contemplated that a break 147 may be formed at an interface between a driver pin 141 and a key pin 142, for example in a tumbler mechanism that does not include a master pin 144. Those skilled in the art will readily recognize that when the break 147 of a particular lock tumbler mechanism 149 is aligned with the inner shear line 182, the tumbler mechanism 149 does not prevent rotation of the plug 120 relative to the shell 110. Thus, when each of the tumbler mechanisms 149 is in an unlocking position in which a break 147 is aligned with the inner shear line 182, the tumbler assembly 140 is in its unlocking state and does not prevent rotation of the plug 120 relative to the shell 110.

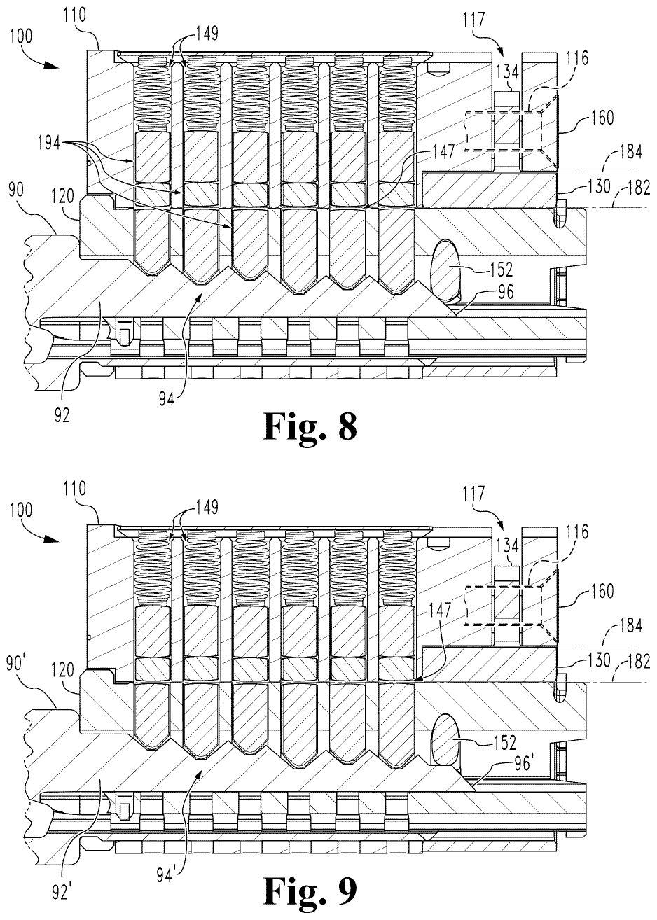

As will be appreciated, the bias members 143 bias the lock tumbler assembly 140 toward a locking state (FIG. 5) in which the lock tumbler assembly 140 prevents rotation of the plug 120 relative to the shell 110. Upon insertion of an appropriate key 90, the lock tumbler assembly 140 moves to its unlocking state (FIGS. 8 and 9) in which the lock tumbler assembly 140 does not prevent rotation of the plug 120 relative to the shell 110. While each of the illustrated lock tumbler mechanisms 149 is provided in the form of a pin tumbler mechanism, it should be appreciated that other forms of tumbler mechanisms may be utilized, such as disc tumblers, wafer tumblers, finger pins, sidebars, and others.

The control tumbler mechanism 150 is received in the control tumbler shaft 195 and generally includes a shell control tumbler 151 and a plug control tumbler 152, and may further include an intermediate control tumbler 153. The shell control tumbler 151 is operable to be received in the blind bore 115, the plug control tumbler 152 is seated in the plug control tumbler cavity 125, and the intermediate pin 153 is seated in the aperture 135 of the control member 130. Moreover, the control tumbler mechanism 150 includes at least one break, and in the illustrated form includes an outer break 155 and an inner break 156. The outer break 155 is defined between the shell control tumbler 151 and the intermediate control tumbler 153, and the inner break 156 is defined between the plug control tumbler 152 and the intermediate control tumbler 153.

The illustrated control tumbler mechanism 150 further includes a bias member such as a spring 154 that is seated in the blind bore 115 and biases the shell control tumbler 151 into contact with the intermediate pin 153. As described herein, the control tumbler mechanism 150 has a first state and a second state, and the control key 90′ is operable to move the control tumbler mechanism 150 from the first state to the second state. In the first state (FIG. 10), the control tumbler mechanism 150 rotationally couples the control member 130 with the shell 110 and decouples the control member 130 from the plug 120 to thereby permit rotation of the plug 120 relative to the shell 110 and control member 130. In the second state (FIG. 11) in which the control tumbler mechanism 150 rotationally couples the control member 130 with the plug 120 and decouples the control member 130 from the shell 110 to thereby permit rotation of the plug 120 and control member 130 relative to the shell 110.

In the illustrated form, the lock cylinder 100 is arranged to prevent the intermediate control tumbler 153 and the shell control tumbler 151 from entering the plug control tumbler cavity 125. More particularly, the illustrated aperture 135 includes a shoulder 135′ that prevents the intermediate control tumbler 153 from entering the plug control tumbler cavity 125. It is also contemplated that the intermediate control tumbler 153 may be prevented from entering the plug control tumbler cavity 125 in an additional and/or alternative manner. For example, the plug control tumbler cavity 125 may have a lesser diameter than the intermediate control tumbler 153 to thereby prevent the intermediate control tumbler 153 from entering the plug control tumbler cavity 125. In the illustrated embodiment, the shoulder 135′ retains the intermediate control tumbler 153 within the aperture against the biasing of the spring 154 such that the inner break 156 expands to a lost motion gap (FIG. 4) that permits limited movement of the plug control tumbler 152 before the plug control tumbler 152 contacts the intermediate control tumbler 153.

The stop member 160 extends into the longitudinal bore 116 of the tower 113 and through the limit slot 136 of the control member 130. With the stop member 160 received in the limit slot 136, the stop member 160 limits the control member 130 to rotation between its holding position (FIG. 6) and its release position (FIG. 7). During assembly, the control member 130 may be mounted to the shell 110 with the control lug 134 at least partially received in the transverse slot 117, and the stop member 160 may be inserted into the longitudinal bore 116 from the distal end of the tower 113 such that the stop member 160 enters the limit slot 136. In certain forms, the transverse slot 117 may be defined in part by a stop wall 117′ that serves as a secondary stop to further discourage rotation of the control member 130 beyond the release position illustrated in FIG. 7.

With additional reference to FIG. 8, the operating key 90 is operable to move the tumbler assembly 140 to its unlocking state. The operating key 90 includes a shank 92 having a bitting code 94 configured to align a break 147 of each tumbler mechanism 149 with the inner shear line 182 when the shank 92 is fully received in the keyway 122. The shank 92 has a distal nose 96 that extends beyond the distalmost tumbler mechanism 149. While the nose 96 may engage the plug control tumbler 152, the operating key 90 is inoperable to move the control tumbler mechanism 150 from its first state (FIG. 10) to its second state (FIG. 11).

With additional reference to FIG. 9, the control key 90′ is also operable to move the tumbler assembly 140 to its unlocking state. The control key 90′ includes a shank 92′ having a bitting code 94′ configured to align a break 147 of each tumbler mechanism 149 with the inner shear line 182 when the shank 92′ is fully received in the keyway 122. The nose of the control key 90′ has an extension 96′ that extends distally farther than the nose 96 of the operating key 90 such that the control key 90′ is operable to engage the plug control tumbler 152 to thereby move the control tumbler mechanism 150 from its first state (FIG. 10) to its second state (FIG. 11).

As should be evident from the foregoing, each of the keys 90, 90′ in the system 80 is operable to move the tumbler assembly 140 from its locking state to its unlocking state. In the illustrated form, the operating key 90 and the control key 90′ are keyed alike such that each of the bitting codes 94, 94′ is identical. It is also contemplated that the keys 90, 90′ may be keyed differently, for example in embodiments in which the tumbler assembly 140 includes one or more master pins 143. Moreover, the control key 90′ is operable to move the control tumbler mechanism 150 from its first state to its second state, whereas the operating key 90 is inoperable to move the control tumbler mechanism 150 from its first state to its second state.

With additional reference to FIGS. 10-12, the control tumbler mechanism 150 is seated in the control tumbler shaft 195 and is operable to alternately couple the control member 130 with each of the shell 110 and the plug 120. As described herein, the control tumbler mechanism 150 has a first state (FIG. 8) in which the control tumbler mechanism 150 rotationally couples the control member 130 with the shell 110, and a second state (FIGS. 9 and 10) in which the control tumbler mechanism 150 rotationally couples the control member 130 with the plug 120.

FIG. 10 illustrates the lock cylinder 100 prior to insertion of the control key 90′. In this state, the control member 130 is in its holding position, in which the control lug 134 projects outward from the tower 113 and beyond the footprint of the shell 110. Additionally, the control tumbler mechanism 150 is in its first state, in which the control tumbler mechanism 150 rotationally couples the control member 130 with the shell 110 and rotationally decouples the control member 130 from the plug 120. In this state, the shell control tumbler 151 crosses the outer shear line 184 to thereby prevent rotation of the control member 130 relative to the shell 110. Moreover, with the intermediate control tumbler 153 blocked from entering the plug control tumbler cavity 125 (e.g., by the shoulder 135′), the inner break 156 is aligned with the inner shear line 182 such that the control member 130 is rotationally decoupled from the plug 120. As a result, the control tumbler mechanism 150 does not interfere with normal locking/unlocking operation of the lock cylinder 100. As noted above, the control tumbler mechanism 150 may be biased to the first state by a spring 154.

FIG. 11 illustrates the lock cylinder 100 after insertion of the control key 90′ and prior to rotation of the control key 90′. In this state, the control member 130 remains in its holding position, while the control tumbler mechanism 150 has moved to its second state. In its second state, the control tumbler mechanism 150 rotationally couples the control member 130 with the plug 120 and rotationally decouples the control member 130 from the shell 110. More particularly, the plug control tumbler 152 crosses the inner shear line 182 formed between the control member 130 and the plug 120 to thereby prevent relative rotation of the plug 120 and the control member 130. The shell control tumbler 151, however, is wholly received in the blind bore 115 such that the outer break 155 is aligned with the outer shear line 184. As a result, the control member 130 is operable to rotate with the plug 120 relative to the shell 110.

FIG. 12 illustrates the lock cylinder 100 after rotation of the control key 90′, which results in rotation of the plug 120 to its rotated position. This rotation of the plug 120 causes a corresponding rotation of the control member 130 to its release position, in which the control lug 134 is received within the slot 117 defined in the tower 113. The outer break 155 allows the control tumbler mechanism 150 to break from a continuous column during this rotation of the control member 130 relative to the shell 110.

As should be evident from the foregoing, the control tumbler mechanism 150 is operable to alternately couple the control member 130 to each of the shell 110 and the plug 120. As used herein, the term “alternately couple” may be used to indicate that the control tumbler mechanism 150 has a first state in which the control tumbler mechanism 150 couples the control member 130 to the shell 110 and decouples the control member 130 from the plug 120, and a second state in which the control tumbler mechanism 150 couples the control member 130 to the plug 120 and decouples the control member 130 from the shell 110.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected.

It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A lock cylinder, comprising:
a shell that at least partially defines each of a chamber and a control tumbler shaft;
a control member mounted for rotation relative to the shell between a hold position and a release position, the control member further defining the control tumbler shaft;
a plug rotatably seated in the chamber, the plug at least partially defining a lock tumbler shaft and the control tumbler shaft;
a lock tumbler mechanism seated in the lock tumbler shaft and operable to selectively prevent rotation of the plug relative to the shell; and
a control tumbler mechanism seated in the control tumbler shaft and operable to alternately couple the control member with each of the shell and the plug;
wherein the lock tumbler shaft and the control tumbler shaft are oblique to one another.

2. The lock cylinder of claim 1, wherein the shell further defines the control tumbler shaft.

3. The lock cylinder of claim 2, wherein the shell comprises a blind bore that further defines the control tumbler shaft.

4. The lock cylinder of claim 1, further comprising a stop member that extends through a limit slot in the control member to thereby limit the control member to rotation between the hold position and the release position.

5. The lock cylinder of claim 4, wherein the shell comprises a transverse slot;
wherein the control member comprises a control lug received in the transverse slot; and
wherein the limit slot is formed in the control lug.

6. The lock cylinder of claim 1, wherein the control member comprises a sleeve further defining the chamber in which the plug is rotatably seated.

7. A system comprising the lock cylinder of claim 1, the system further comprising:
an operating key operable to actuate the lock tumbler mechanism and inoperable to actuate the control tumbler mechanism; and
a control key operable to actuate both the lock tumbler mechanism and the control tumbler mechanism.

8. A lock cylinder configured for mounting in a housing, the lock cylinder comprising:
a shell;
a plug rotatably mounted in the shell, the plug having a home position and a rotated position;
a control member mounted for rotation relative to the shell between a holding position, in which the control member prevents removal of the lock cylinder from the housing, and a release position, in which the control member permits removal of the lock cylinder from the housing;
a lock tumbler mechanism selectively retaining the plug in the home position, the lock tumbler mechanism comprising a lock tumbler mounted for movement along a first axis;
a control tumbler mechanism selectively retaining the control member in the holding position, the control tumbler mechanism comprising a control tumbler mounted for movement along a second axis transverse to the first axis.

9. The lock cylinder of claim 8, wherein the plug comprises:
a first plug cavity extending along and defining the first axis;
a second plug cavity extending along and defining the second axis; and
a keyway connected with the first cavity and the second cavity.

10. The lock cylinder of claim 9, wherein the shell comprises:
a first shell cavity that aligns with the first plug cavity when the plug is in the home position, wherein the first shell cavity is operable to receive a portion of the lock tumbler mechanism; and
a second shell cavity that aligns with the second plug cavity when the plug is in the home position, wherein the second shell cavity is operable to receive a portion of the control tumbler mechanism.

11. The lock cylinder of claim 10, wherein the second shell cavity comprises a blind bore.

12. The lock cylinder of claim 8, wherein the control tumbler mechanism has a first state in which the control tumbler mechanism rotationally couples the control mechanism with the shell, and a second state in which the control tumbler mechanism rotationally couples the control mechanism with the plug.

13. A system comprising the lock cylinder of claim 12, the system further comprising:
a control key operable to move the lock tumbler mechanism from a locking state to an unlocking state and operable to move the control tumbler mechanism from the first state to the second state; and
an operating key operable to move the lock tumbler mechanism from the locking state to the unlocking state and inoperable to move the control tumbler mechanism from the first state to the second state.

14. A lock cylinder configured for mounting in a housing, the lock cylinder comprising:
a shell comprising a body portion and a tower that extends from the body portion along a first axis, wherein the body portion partially defines a chamber that extends along a longitudinal axis, and wherein the tower partially defines a control tumbler shaft;
a control member comprising a sleeve that further defines the chamber, a control lug projecting from the sleeve, and an aperture that further defines the control tumbler shaft, wherein the control member is rotatable about the longitudinal axis between a hold position in which the control lug projects outward from the tower, and a release position in which the control lug is received in the tower;
a plug rotatably seated in the chamber, the plug comprising a keyway that extends along and defines a reference plane, and a control tumbler cavity that extends at an oblique angle relative to the reference plane and further defines the control tumbler shaft; and
a control tumbler mechanism seated in the control tumbler shaft, wherein the control tumbler mechanism has a first state in which the control tumbler mechanism couples the control member with the shell, and a second state in which the control tumbler mechanism couples the control member with the plug;
wherein the control tumbler mechanism is configured to move from the first state to the second state in response to insertion of a control key into the keyway.

15. The lock cylinder of claim 14, wherein the control tumbler mechanism comprises:
a first control tumbler operable to selectively couple the control member with the shell; and
a second control tumbler operable to selectively couple the control member with the plug.

16. The lock cylinder of claim 15, wherein the control tumbler mechanism further comprises an intermediate control tumbler positioned in the aperture and between the first control tumbler and the second control tumbler.

17. The lock cylinder of claim 16, wherein the control tumbler shaft comprises a shoulder preventing the intermediate control tumbler from entering the control tumbler cavity.

18. The lock cylinder of claim 15, wherein the control tumbler mechanism further comprises a lost motion gap allowing the second control tumbler to move relative to the first control tumbler during insertion of the control key to the keyway.

19. The lock cylinder of claim 15, wherein the control tumbler mechanism further comprises a spring biasing the first control tumbler toward the plug.

20. The lock cylinder of claim 14, wherein the tower comprises a blind bore that partially defines the control tumbler shaft.

21. A system comprising the lock cylinder of claim 14, the system further comprising:
the control key, wherein the control key is operable to move the control tumbler mechanism from the first state to the second state; and
an operating key, wherein the operating key is inoperable to move the control tumbler mechanism from the first state to the second state.
